(19) United States
(12) Patent Application Publication
(10) Pub. No.: US 2014/0065041 A1
(43) Pub. Date: Mar. 6, 2014

(54) EMISSIONS AFTERTREATMENT COMPONENT RECOVERY SYSTEM AND METHOD

(71) Applicant: Cummins Emission Solutions, Inc., Columbus, IN (US)

(72) Inventors: Tamas Szailer, Seymour, IN (US); Junhui Li, Columbus, IN (US); Aleksey Yezerets, Columbus, IN (US); Ross Berryhill, Nashville, IN (US); Matthew Henrichsen, Columbus, IN (US); Nathan Ottinger, Madison, WI (US)

(73) Assignee: Cummins Emission Solutions, Inc., Columbus, IN (US)

(21) Appl. No.: 14/012,011

(22) Filed: Aug. 28, 2013

Related U.S. Application Data
(60) Provisional application No. 61/694,210, filed on Aug. 28, 2012.

(51) Int. Cl. B01D 53/94; F01N 3/20

(52) U.S. Cl. CPC B01D 53/9495; F01N 3/20
USPC 423/212; 422/108

(57) ABSTRACT

Methods and systems include an operation to interpret a face-plugging index and/or a reduction in an expected oxidation efficiency of an oxidation catalyst disposed in an internal combustion engine aftertreatment system, and in response to the face-plugging index or the reduction oxidation efficiency reaching a threshold value, an operation to provide a catalyst element reversal command.

### CROSS-REFERENCE TO RELATED APPLICATION

The present application claims priority to Provisional App. No. 61/694,210 filed on Aug. 28, 2012, which is hereby incorporated by reference.

### BACKGROUND

The technical field generally relates to recovery of aftertreatment components. Many aftertreatment systems for engines include an oxidation catalyst as a component of the system. The oxidation catalyst is often in series and upstream of other aftertreatment components. The oxidation catalyst treats hydrocarbons or other exhaust constituents. When the oxidation catalyst degrades, the downstream components relying upon the mechanisms of the oxidation catalyst can operate improperly or even fail. Presently known oxidation catalysts sometimes exhibit failure modes that cannot be explained through normal catalyst aging models, and that are not amenable to conventional regeneration and recovery efforts. Therefore, further technological developments are desirable in this area.

### SUMMARY

An example method and system includes an operation to interpret a face-plugging index and/or a reduction in an expected oxidation efficiency of an oxidation catalyst disposed in an internal combustion engine aftertreatment system, and in response to the face-plugging index or the reduction oxidation efficiency reaching a threshold value, an operation to provide a catalyst element reversal command.

This summary is provided to introduce a selection of concepts that are further described below in the illustrative embodiments. This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

FIG. 1 is a schematic of an aftertreatment system for an engine.

FIG. 2 is a schematic of one embodiment of a processing subsystem for emissions aftertreatment component recovery.

FIG. 3 is a chart showing a summary of the rate of overall hydrocarbon conversion efficiency loss for a population of oxidation catalysts versus mileage.

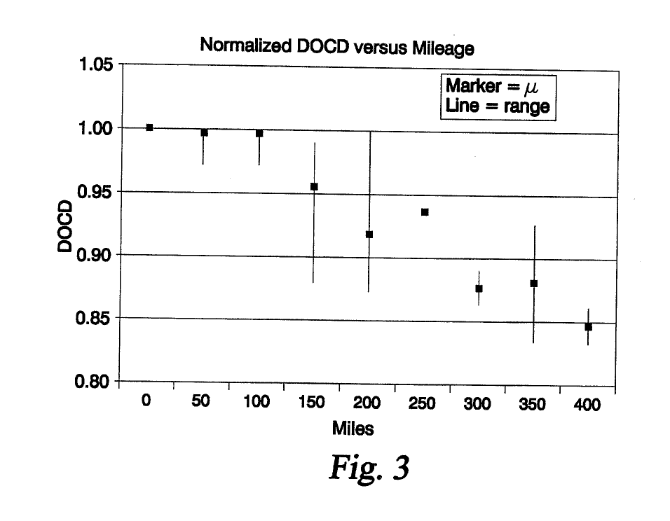

FIG. 4 is a chart showing a comparison of oxidation activity levels of particular oxidation catalysts before and after reversal of the oxidation catalyst cores.

FIG. 5 is a chart showing a comparison of hydrocarbon lightoff temperatures of the oxidation catalysts of FIG. 4 before and after reversal of the oxidation catalyst cores.

FIG. 6 is a flow diagram of a catalyst element reversal procedure.

### DESCRIPTION OF ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated embodiments, and any further applications of the principles of the invention as illustrated therein as would normally occur to one skilled in the art to which the invention relates are contemplated herein.

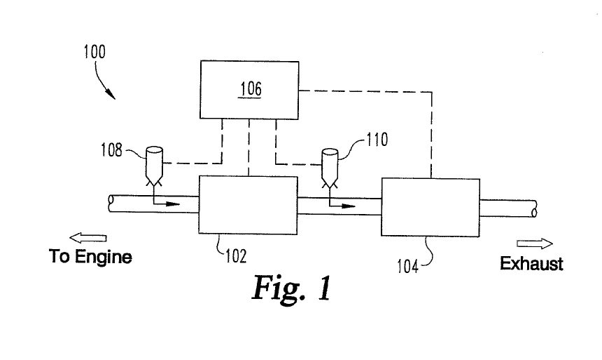

Referencing FIG. 1, a system 100 includes an oxidation catalyst 102, for example a diesel oxidation catalyst DOC. System 100 also includes a hydrocarbon (HC) injector 108 upstream of oxidation catalyst 102. In one embodiment, oxidation catalyst 102 is a flow-through catalyst (e.g. as opposed to a wall flow catalyst) having a catalytically active metal thereupon, such as platinum, osmium, iridium, ruthenium, rhodium, and/or palladium (e.g. a platinum group metal). While the oxidation catalyst 102 is a flow-through catalyst, although other types of flow regimes through the oxidation catalyst 102 are contemplated herein. In certain embodiments, the system 100 further includes a selective catalytic reduction (SCR) component 104. The example system 100 includes a reductant injector 110 (e.g. urea, ammonia, and/or hydrocarbon), which injects reductant into the exhaust gases at a position upstream of the SCR component 104.

A system 100 having a low performance oxidation catalyst 102, for example with low unburned HC conversion values and/or low NO to NO₂ oxidation conversion values, may have undesirable effects in the SCR component 104. For example, a portion of unreacted hydrocarbons may oxidize in the SCR catalyst 104, interfere with the intended SCR reactions in the SCR catalyst 104, and/or cause slipping from the system 100 of hydrocarbons and/or unreacted ammonia. Where NO to NO₂ conversion values are low, the rate of NOₓ conversion in the SCR catalyst 104 may fall to below-design levels, causing a system fault, failure, or emissions exceedance.

Additionally or alternatively, a system 100 having a particulate filter (not shown) may likewise be adversely affected by a low performance oxidation catalyst 102, for example experiencing lower than expected temperatures, combustion of HC within the particulate filter, and/or lower than expected particulate oxidation rates (e.g. due to a lower fraction of NO₂ present at the particulate filter than designed or expected).

In certain embodiments, the system 100 further includes a controller 106 structured to perform certain operations to recover, or to provide information assisting in the recovery of, the oxidation catalyst 102. In certain embodiments, the controller forms a portion of a processing subsystem including one or more computing devices having memory, processing, and communication hardware. The controller 106 may be a single device or a distributed device, and the functions of the controller 106 may be performed by hardware or software.

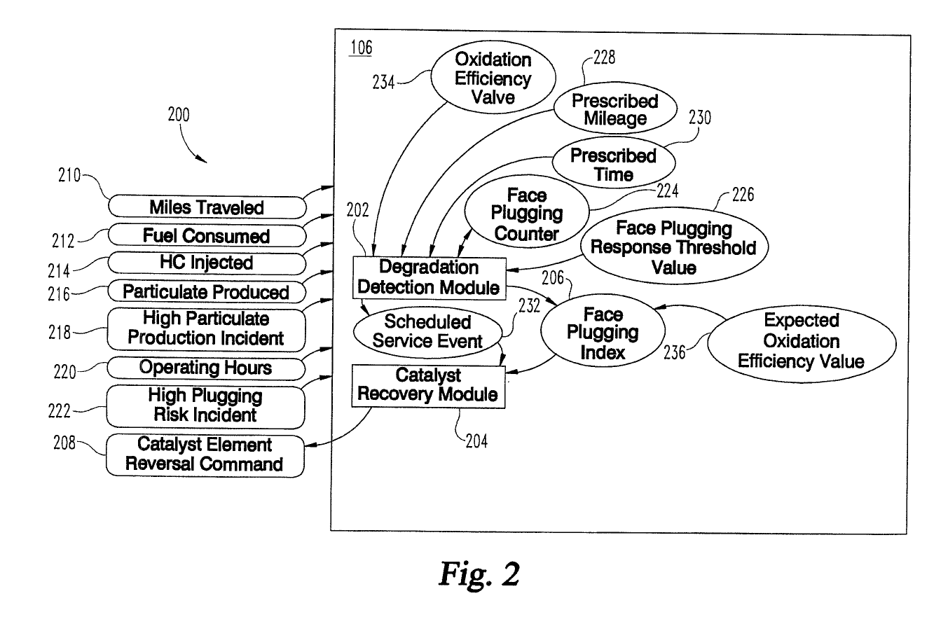

In certain embodiments, the controller 106 includes one or more modules structured to functionally execute the operations of the controller 106. In certain embodiments, the controller includes a degradation detection module 202 and a catalyst recovery module 204. The description herein including modules emphasizes the structural independence of the aspects of the controller 106, and illustrates one grouping of operations and responsibilities of the controller 106. Other groupings that execute similar overall operations are understood within the scope of the present application. Modules may be implemented in hardware and/or software on a non-transient computer readable storage medium, and modules may be distributed across various hardware or software components. More specific descriptions of certain embodiments of controller operations are included in the section referencing FIG. 2.

Certain operations described herein include operations to interpret one or more parameters. Interpreting, as utilized herein, includes receiving values by any method known in the art, including at least receiving values from a datalink or network communication, receiving an electronic signal (e.g. a voltage, frequency, current, or PWM signal) indicative of the value, receiving a software parameter indicative of the value, reading the value from a memory location on a non-transient computer readable storage medium, receiving the value as a run-time parameter by any means known in the art, and/or by receiving a value by which the interpreted parameter can be calculated, and/or by referencing a default value that is interpreted to be the parameter value.

FIG. 2 is a schematic illustration of a processing subsystem 200 including a controller 106. The controller 106 includes a degradation module 202 that interprets a face-plugging index 206 for the oxidation catalyst 102. The operation to interpret the face-plugging index 206 should be understood broadly to include any parameter or operation that can be correlated to a face-plugging occurrence of the oxidation catalyst 102. Example and non-limiting operations to interpret the face-plugging index 206 include: incrementing a face-plugging counter 224 in response to a face-plugging occurrence, and comparing the face-plugging counter 224 to a face plugging response threshold value 226; accumulating a number of miles traveled 210; accumulating an amount of fuel consumed 212; accumulating an amount of aftertreatment hydrocarbon injected 214 (e.g. through an HC injector 108 and/or through very late post injection in an engine); accumulating an amount of particulate produced 216; accumulating a number of hours of operation 220; and/or accumulating a number of high plugging risk incidents 222.

The accumulating operations may be accumulated through a relevant period, for example since the manufacture time of the system 100, since a last service event for the system, and/or accumulated since a manually activated reset event. The accumulation parameter may be negative or positive, for example the degradation detection module 202 may increment the accumulation parameter in response to events correlated to face plugging, and the degradation detection module 202 may decrement the accumulation parameter in response to events that are correlated to preventing or delaying face plugging of the oxidation catalyst 102. Operations to accumulate miles (distance) or operating hours (time) may include only distances or times that are correlated to face plugging, for example only times where the engine is fueling, providing at least a threshold amount of power, etc. Operations to accumulate particulate produced may include estimating all emitted particulates, and/or estimating only particulates produced under certain operating conditions (e.g. at low temperatures and/or high particulate production rates). A face plugging counter may accumulate discrete events that are known to increase the chances of a face plugging event occurring on oxidation catalyst 102, and may include giving differential risk events a differential counter increment value, and/or providing risk lowering events with a counter decrement value.

High risk plugging incidents can include any type of high risk plugging event understood in the art, including at least events known to have a risk of wetting the face of the oxidation catalyst 102, including without limitation hydrocarbon dosing occurring at a low exhaust temperature, and/or potential condensation conditions occurring that could flow through to the exhaust (e.g. condensation in an EGR system occurring just as the engine goes into a motoring condition). All described operations, accumulators, and examples are non-limiting.

An example controller 106 includes the degradation detection module 202 providing a scheduled service event value 232 in response to a prescribed mileage 228 and/or a prescribed operating time 230 of the system. It is a mechanical step for one of skill in the art, having the benefit of the disclosures herein, to determine accumulated values or thresholds, and/or prescribed operating times or distances, that correlate to a specified risk level of an oxidation catalyst experiencing face plugging for a particular system. The determined values may be made from field experience, in response to product return or service event data ordinarily determined in the course of business, in response to catalyst manufacturer data, and/or through straightforward testing of the type ordinarily performed in design and calibration of engine-aftertreatment systems.

The controller 106 includes the catalyst recovery module 204 providing a catalyst element reversal command 208 in response to interpreting the face plugging index 206. Example values for the face plugging index 206 may be qualitative (e.g. “plugged”, “partially plugged”, “clean”, etc.) and/or quantitative. The catalyst element reversal command 208 may be a fault code, a value communicated to a datalink or network, a value stored on a computer readable medium in non-transitory memory, an electrical output value (e.g. a voltage provided to a lamp), or any other type of communication understood in the art. In certain embodiments, the catalyst element reversal command 208 notifies an operator that a service event is required. Additionally or alternatively, the catalyst element reversal command 208 notifies a service provider that a service event is required. The catalyst element reversal command 208 may be active (e.g. lighting a malfunction indicator lamp, a check engine light, and/or flashing a light at engine startup) and/or passive (e.g. a stored value that must be checked, a fault code available to a fault code listing/OBD device, and/or a datalink communication that is provided to a public datalink continuously or on request).

In certain embodiments, the degradation detection module 202 interprets an oxidation catalyst oxidation efficiency value 234, and determines the face plugging index 206 by comparing the oxidation catalyst oxidation efficiency value 234 to an expected oxidation catalyst oxidation efficiency value 236. The expected oxidation catalyst oxidation efficiency value 236 may be determined by correlating any available parameter to determine an aging degradation value for the oxidation catalyst 102, and then estimating the current oxidation efficiency value 234 that should be present in the oxidation catalyst 102 under present conditions. The interpreted oxidation catalyst oxidation efficiency value 234 is then compared to the expected value. A catalyst reversal command 238 is initiated when the deviation of the interpreted value exceeds the expected value by a predetermined amount. Example operations to interpret the current oxidation efficiency value include determining an HC value upstream and downstream of the oxidation catalyst 102, determining a temperature rise value across the oxidation catalyst 102, and/or determining an NO to NO2 conversion value across the oxidation catalyst 102. Any other catalyst activity determination known in the art may be utilized to estimate the oxidation efficiency of the oxidation catalyst 102.

Example operations to determine the aging degradation value include performing standard aging tests or measurements on an oxidation catalyst, and tracking an aging parameter to estimate the current aging degradation value of the oxidation catalyst 102. Without limiting the present disclosure to a particular theory of operation, an oxidation catalyst having face plugging present can experience a much greater oxidation efficiency loss than is explainable through ordinary catalyst degradation by aging. An aged oxidation catalyst experiences some loss in catalyst activity, which is more observable at low temperatures and is usually less significant at high temperatures. A face plugged oxidation catalyst can experience degradation 15% to 30% worse than a merely aged oxidation catalyst, including loss of activity at high temperatures. In one example, an oxidation catalyst having 400,000 operating miles was observed to have a 15% deterioration in catalyst activity, while a face-plugged oxidation catalyst was observed to have a 30% deterioration in catalyst activity. The loss of catalyst activity of the face plugged oxidation catalyst may be explained by the reduction in catalyst mass (or volume) in fluid contact with the exhaust, and the consequent increase in the catalyst space velocity observed as a loss in catalyst activity. In certain embodiments, face plugging can be detected by determining the expected aging degradation value that is indicative of an aged activity level of the oxidation catalyst, and determining that the given oxidation catalyst with the expected current aging degradation value has significantly reduced catalyst activity relative to the activity level that is indicated by the expected aging degradation value of the oxidation catalyst.

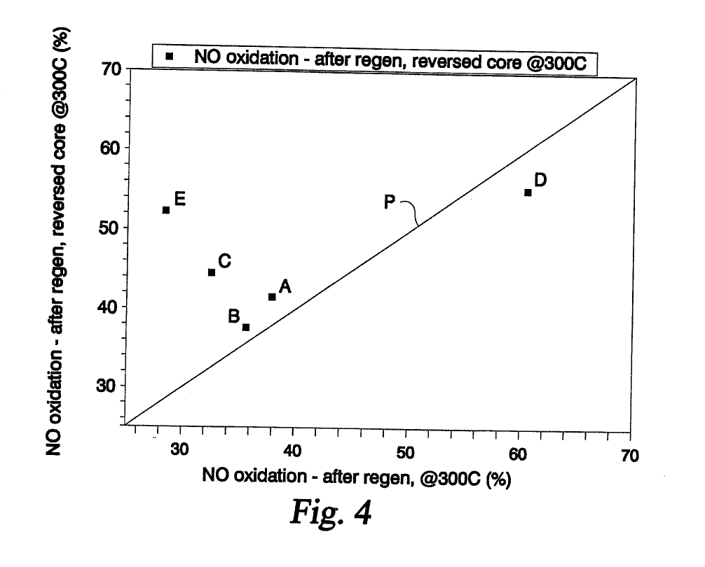

Referencing FIG. 4, it can be seen that oxidation catalyst degradation, expressed as HC conversion efficiency, occurs in some catalyst units for a particular system at 150,000 miles of operation. The amount of the deterioration, and the range of observed efficiencies for a given catalyst, both vary considerably across the oxidation catalysts. At least some of the observed variability and deterioration may be due to face plugging issues.

Catalytic activity for aged oxidation catalysts can be restored by reversing the catalyst cores, for example by reversing the entire oxidation catalyst component, or by removing the catalyst core from the housing and replacing the core into the housing in a reversed position. Referencing FIG. 4, experimental data illustrates NO oxidation activity before reversal along the x-axis and NO oxidation activity after reversal along the y-axis. Line P indicates an unchanged NO oxidation activity before and after reversal. It can be observed that NO oxidation activity is generally restored or improved following a core reversal in aged catalyst components.

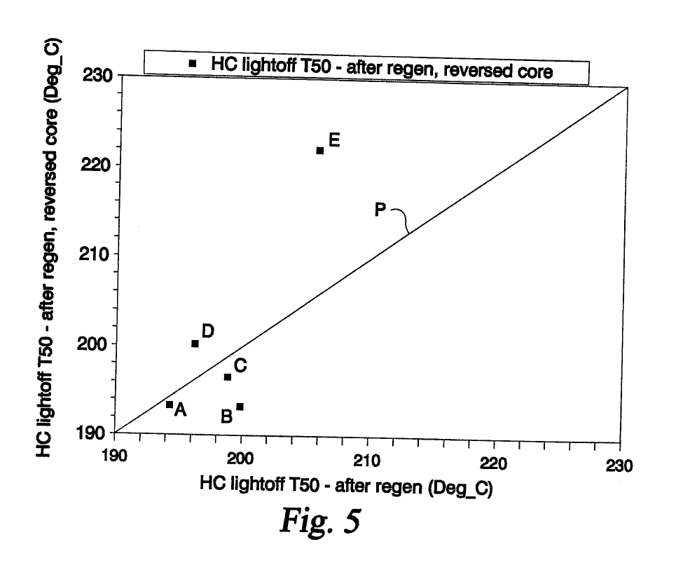

Referencing FIG. 5, experimental data illustrates that HC lightoff temperatures, indicative of HC oxidation activity, are generally lowered following a core reversal, where line P indicates unchanges HC lightoff temperatures before and after reversal. One data point, labeled “E”, experiences a significant lightoff temperature increase. It is noted in FIG. 4 that the E core experienced a very significant improvement in NO oxidation activity. It is possible that the E core was damaged in more ways than just being face plugged, and/or that the HC lightoff data is just an outlier.

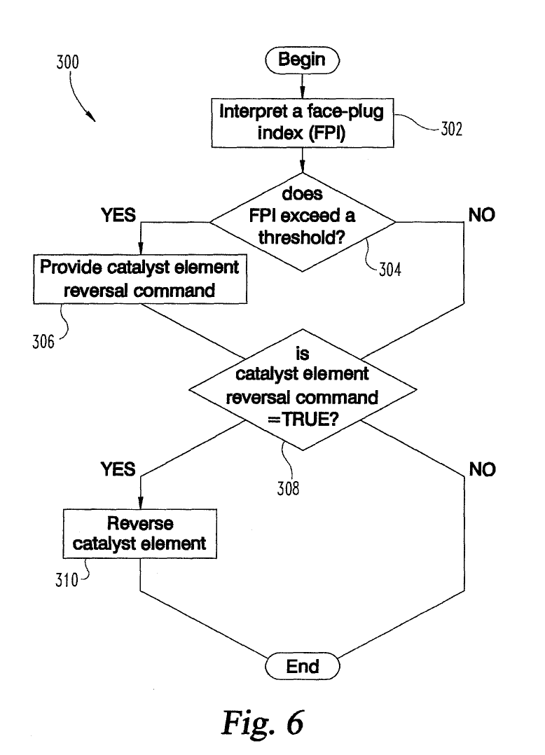

The schematic flow diagram depicted in FIG. 6, and related description which follows, provides an illustrative embodiment of performing procedures for recovering an oxidation catalyst. Operations illustrated are understood to be exemplary only, and operations may be combined or divided, and added or removed, as well as re-ordered in whole or part, unless stated explicitly to the contrary herein. Certain operations illustrated may be implemented by a computer executing a computer program product on a non-transient computer readable storage medium, where the computer program product comprises instructions causing the computer to execute one or more of the operations, or to issue commands to other devices to execute one or more of the operations.

An example procedure 300 includes an operation 302 to interpret a face-plugging index for an oxidation catalyst disposed in an internal combustion engine aftertreatment system. The procedure includes an operation 304 to determine whether the face-plugging index exceeds a threshold value, and in response to the operation 304 determining YES, the procedure 300 includes an operation 306 to provide a catalyst element reversal command. The procedure 300 further includes an operation 308 to determine whether the catalyst element reversal command has a value of TRUE, and the procedure 300 further includes an operation 310 to reverse the catalyst element in response to the operation 308 determining YES.

Various aspects of the systems and methods disclosed herein are contemplated. According to one aspect, a method includes interpreting a face-plugging index for an oxidation catalyst disposed in an internal combustion engine aftertreatment system and, in response to the face-plugging index reaching a threshold value, providing an oxidation catalyst reversal command.

In one embodiment, the method includes reversing a core of the oxidation catalyst in response to the oxidation catalyst reversal command. In another embodiment of the method, interpreting the face-plugging index includes incrementing a face-plugging counter in response to a face-plugging occurrence and comparing the face-plugging counter to a face-plugging counter threshold value.

In a further embodiment of the method, interpreting the face-plugging index includes at least one of: accumulating a number of miles traveled; accumulating an amount of fuel consumed; accumulating an amount of aftertreatment hydrocarbon injected; accumulating an amount of particulate produced; accumulating a number of high particulate production incidents; accumulating a number of hours of operation; and accumulating a number of high plugging risk incidents. In one refinement of this embodiment, accumulating includes accumulating during a period initiated at one of a time of manufacture of the aftertreatment system, a time of a last service event for the aftertreatment system, and a time of a manually activated reset event.

In another embodiment of the method, interpreting the face-plugging index includes performing a service check at a prescribed mileage or a prescribed time interval. In a further embodiment, the oxidation catalyst is a flow-through diesel oxidation catalyst.

In yet another embodiment of the method, interpreting the face plugging index includes interpreting a current oxidation efficiency value of the oxidation catalyst and comparing the current oxidation efficiency value to an expected oxidation efficiency value of the oxidation catalyst. The threshold value is a deviation of the current oxidation efficiency value from the expected oxidation efficiency value. In one refinement of this embodiment, interpreting the current oxidation efficiency value includes at least one of determining a hydrocarbon value upstream and downstream of the oxidation catalyst, determining a temperature rise value across the oxidation catalyst, and determining an NO to NO2 conversion value across the oxidation catalyst. In another refinement of this embodiment, the expected oxidation efficiency value is correlated to an aging degradation value of the oxidation catalyst.

According to another aspect, a method includes interpreting an oxidation efficiency value for an oxidation catalyst disposed in an aftertreatment system of an internal combustion engine; comparing the oxidation efficiency value to an expected oxidation efficiency value of the oxidation catalyst; and in response to the oxidation efficiency value deviating from the expected oxidation efficiency value by more than a threshold amount, providing an output indicating a core reversal of the oxidation catalyst.

In one embodiment of the method, the output is at least one of an active output and a passive output. In another embodiment, the oxidation catalyst is a flow-through diesel oxidation catalyst having a catalytically active metal thereon. In a further embodiment of the method, interpreting the oxidation efficiency value includes at least one of determining a hydrocarbon value upstream and downstream of the oxidation catalyst, determining a temperature rise value across the oxidation catalyst, and determining an NO to NO2 conversion value across the oxidation catalyst. In yet another embodiment of the method, the expected oxidation efficiency value is correlated to an aging degradation value of the oxidation catalyst.

According to another aspect, a system includes an oxidation catalyst fluidly coupled to an internal combustion engine on an upstream side of the oxidation catalyst to receive exhaust gas from the internal combustion engine. The oxidation catalyst is further connected to at least one secondary aftertreatment component on a downstream side of the oxidation catalyst. The oxidation catalyst comprising a flow-through oxidation catalyst having at least one catalyst material selected from the catalyst materials comprising: platinum, osmium, iridium, ruthenium, rhodium, and palladium. The system further includes an electronic controller configured to receive operational parameters relating to operation of the internal combustion engine. The controller includes a degradation detection module structured to interpret a face-plugging index for the oxidation catalyst in response to the operational parameters and a catalyst recovery module structured to provide a catalyst element reversal command in response to the face-plugging index reaching a threshold value.

In one embodiment of the system, the degradation detection module is structured to increment a face-plugging counter in response to a face-plugging occurrence and compare the face-plugging counter to a face-plugging counter threshold value. In another embodiment of the system, the degradation detection module is configured to interpret the face-plugging index by at least one of: accumulating a number of miles traveled; accumulating an amount of fuel consumed; accumulating an amount of aftertreatment hydrocarbon injected; accumulating an amount of particulate produced; accumulating a number of high particulate production incidents; accumulating a number of hours of operation; and accumulating a number of high plugging risk incidents.

In another embodiment of the system, the degradation detection module is structured to interpret the face-plugging index by interpreting a current oxidation efficiency value of the oxidation catalyst and comparing the current oxidation efficiency value to an expected oxidation efficiency value of the oxidation catalyst. In a refinement of this embodiment, the degradation detection module is structured to interpret the current oxidation efficiency value by at least one of determining a hydrocarbon value upstream and downstream of the oxidation catalyst, determining a temperature rise value across the oxidation catalyst, and determining an NO to NO2 conversion value across the oxidation catalyst.

While the invention has been illustrated and described in detail in the drawings and foregoing description, the same is to be considered as illustrative and not restrictive in character, it being understood that only certain exemplary embodiments have been shown and described. Those skilled in the art will appreciate that many modifications are possible in the example embodiments without materially departing from this invention. Accordingly, all such modifications are intended to be included within the scope of this disclosure as defined in the following claims.

In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A method, comprising:
interpreting a face-plugging index for an oxidation catalyst disposed in an internal combustion engine aftertreatment system; and
in response to the face-plugging index reaching a threshold value, providing an oxidation catalyst reversal command.

2. The method of claim 1, further comprising reversing a core of the oxidation catalyst in response to the oxidation catalyst reversal command.

3. The method of claim 1, wherein the interpreting the face-plugging index comprises incrementing a face-plugging counter in response to a face-plugging occurrence, and comparing the face-plugging counter to a face-plugging counter threshold value.

4. The method of claim 1, wherein interpreting the face-plugging index includes at least one of: accumulating a number of miles traveled; accumulating an amount of fuel consumed; accumulating an amount of hydrocarbon injected in the internal combustion engine aftertreatment system; accumulating an amount of particulate matter produced; accumulating a number of high amount particulate matter production incidents; accumulating a number of hours of operation; and accumulating a number of high risk face-plugging incidents.

5. The method of claim 4, wherein accumulating includes accumulating during a period initiated at one of a time of manufacture of the Preliminary Amendment aftertreatment system, a time of a last service event for the aftertreatment system, and a time of a manually activated reset event.

6. The method of claim 1, wherein interpreting the face-plugging index includes performing a service check at a prescribed mileage or a prescribed time interval.

7. The method of claim 1, wherein interpreting the face plugging index includes interpreting a current oxidation efficiency value of the oxidation catalyst, and comparing the current oxidation efficiency value to an expected oxidation efficiency value of the oxidation catalyst, and the threshold value is a deviation of the current oxidation efficiency value from the expected oxidation efficiency value.

8. The method of claim 7, wherein interpreting the current oxidation efficiency value includes at least one of determining a hydrocarbon value upstream and downstream of the oxidation catalyst, determining a temperature rise value across the oxidation catalyst, and determining an NO to NO2 conversion value across the oxidation catalyst.

9. The method of claim 7, wherein the expected oxidation efficiency value is correlated to an aging degradation value of the oxidation catalyst.

10. The method of claim 1, wherein the oxidation catalyst is a flow-through diesel oxidation catalyst.

11. A method, comprising:
interpreting an oxidation efficiency value for an oxidation catalyst disposed in an aftertreatment system of an internal combustion engine;
comparing the oxidation efficiency value to an expected oxidation efficiency value of the oxidation catalyst; and
in response to the oxidation efficiency value deviating from the expected oxidation efficiency value by more than a threshold amount, providing an output indicating a core reversal of the oxidation catalyst.

12. The method of claim 11, wherein the output is at least one of an active output and a passive output.

13. The method of claim 11, wherein the oxidation catalyst is a flow-through diesel oxidation catalyst having a catalytically active metal thereon.

14. The method of claim 11, wherein interpreting the oxidation efficiency value includes at least one of determining a hydrocarbon value upstream and downstream of the oxidation catalyst, determining a temperature rise value across the oxidation catalyst, and determining an NO to NO2 conversion value across the oxidation catalyst.

15. The method of claim 11, wherein the expected oxidation efficiency value is correlated to an aging degradation value of the oxidation catalyst.

16. A system, comprising:
an oxidation catalyst fluidly coupled to an internal combustion engine on an upstream side of the oxidation catalyst to receive exhaust gas from the internal combustion engine, wherein the oxidation catalyst is connected to at least one secondary aftertreatment component on a downstream side of the oxidation catalyst, wherein the oxidation catalyst comprising a flow-through oxidation catalyst having at least one catalyst material selected from the catalyst materials comprising: platinum, osmium, iridium, ruthenium, rhodium, and palladium;
a controller configured to receive operational parameters relating to operation of the internal combustion engine, the controller comprising:
a degradation detection module structured to interpret a face-plugging index for the oxidation catalyst in response to the operational parameters; and
a catalyst recovery module structured to provide a catalyst element reversal command in response to the face-plugging index reaching a threshold value.

17. The system of claim 16, degradation detection module is structured to increment a face-plugging counter in response to a face-plugging occurrence and compare the face-plugging counter to a face-plugging counter threshold value.

18. The system of claim 16, wherein the degradation detection module is configured to interpret the face-plugging index by at least one of: accumulating a number of miles traveled; accumulating an amount of fuel consumed; accumulating an amount of hydrocarbon injected into an aftertreatment system; accumulating an amount of particulate matter produced; accumulating a number of high amount of particulate matter production incidents; accumulating a number of hours of operation; and accumulating a number of high risk face-plugging incidents.

19. The system of claim 16, wherein the degradation detection module is structured to interpret the face-plugging index by interpreting a current oxidation efficiency value of the oxidation catalyst and comparing the current oxidation efficiency value to an expected oxidation efficiency value of the oxidation catalyst.

20. The system of claim 19, wherein the degradation detection module is structured to interpret the current oxidation efficiency value by at least one of determining a hydrocarbon value upstream and downstream of the oxidation catalyst, determining a temperature rise value across the oxidation catalyst, and determining an NO to NO2 conversion value across the oxidation catalyst.
